(19) United States
(12) Patent Application Publication
(10) Pub. No.: US 2012/0216010 A1
(43) Pub. Date: Aug. 23, 2012

(54) CIRCUIT MODULE DEVICE WITH ADDRESS GENERATION FUNCTIONS

(76) Inventors: Lin Cheng-Lung, Jhubei City (TW); Che-Chuan Lin, Jhubei City (TW)

(21) Appl. No.: 13/032,778

(22) Filed: Feb. 23, 2011

(51) Int. Cl. G06F 12/10

(52) U.S. Cl. 711/214; 711/E12.018; 711/E12.058

(57) ABSTRACT

The present invention relates generally to a kind of circuit module device with address generation functions, which comprises: A plurality of circuit modules, wherein, each circuit module is a control unit, one signal input end and one signal output end; and thereat, the said control unit has an address generation function; and the signal input ends are being electrically connected in series with signal output ends at a plurality of said circuit modules; a plurality of said circuit modules at least consist of one primary circuit module and one secondary circuit module, in which, the signal output end of said primary circuit module is being electrically connected to the signal input end of said secondary circuit module; and wherein, when signal input end of the said primary circuit module is receiving one primary addressing command, the control unit of said primary circuit module will respond to the said primary addressing command and generate one primary address, and then it will send out one secondary addressing command to the signal input end of said secondary circuit module; in addition, when the signal input end of said secondary circuit module is receiving the said secondary addressing command, the control unit of said secondary circuit module will respond to the said secondary addressing command and generate one secondary address; and thus, it will in turn successfully generate address for each circuit module in this way.

### BACKGROUND OF THE INVENTION

1. Field of the Invention

The present invention relates generally to a kind of circuit module device with address generation functions, and more specifically it relates to a circuit module having a serial number reporting capability and due to this particular capability, thus, it has become a circuit module device with address generation functions which is able to sequentially generate addresses by way of number reporting capability thereof.

2. The Prior Art

The known LED lamp has several features, such as high illuminating efficiency, long service life and low power consumption etc., therefore, LED lamps have already dramatically replaced traditional light bulbs in recent years, and meanwhile it has been widely applied to various decorative light string markets. FIG. 1 is a schematic view showing a known LED lamp module, wherein, it comprises red light-emitting diode 11, green light-emitting diode 12, blue light-emitting diode 13, control unit 14, LED lamp module 15 and input end of sync signal 16 etc. The known LED lamp module 15 consists of red light-emitting diode 11, green light-emitting diode 12, blue light-emitting diode 13 and control unit 14. Whereby, control unit 14 is being electrically connected with red light-emitting diode 11, green light-emitting diode 12 and blue light-emitting diode 13 respectively, which can independently control and make each light-emitting diode illuminating, flashing, selecting color combinations and/or changing colors respectively. Additionally, the control unit 14 is being further electrically connected to the input end of sync signal 16 in order to control the operation of light-emitting diode 11, 12, or 13 while responding to the sync signals received by the signal input of sync signal 16.

Upon the application for light strings, a plurality of known LED lamps 15 are cascaded all together, in which, the input end of sync signal 16 of each LED lamp module 15 is being connected to control center, so that the control center will be able to control and make each LED lamp module 15 illuminating, flashing and/or changing colors while transferring sync control signals to input end of sync signal 16 of the said LED lamp module 15. However, the above-mentioned operational mode only can control the light strings consisting of the known LED lamp module 15 to operate synchronously, and it is impossible to addressing control the operation of each individual LED lamp module 15 to execute the special effects, such as marquee or specific arrangement of texts and images for meeting special requirement.

Since the known LED lamp module 15 does not have any dynamically address-generating function, therefore, once an operator is trying to address each LED lamp module 15, the said operator must pre-write each specific address into each corresponding LED lamp module 15 respectively, so that it is able to successfully control each individual LED lamp module 15 with pre-write address. However, there seems to be a lack of flexibility while using pre-write addresses to configure relevant circuit modules and moreover, it is impossible to change the pre-write addresses to meet the future needs. Furthermore, when it is being applied to light strings, the control center will be unable to accurately control each LED lamp module 15 unless it can record the corresponding information related to the location and address allocated for each LED lamp module 15 in advance, and under this circumstance, not only the relevant operations will become more complicated, but also it has to raise a lot of hardware costs in addition to extra memory spaces.

The disadvantages of the known technique are as follows:

1. The known LED lamp module does not have any dynamically address-generating function;

2. The known LED lamp module seems to be a lack of flexibility while using pre-write addresses to control each individual circuit module; and

3. Whenever the known LED lamp module is being applied to light strings, its control center must record the corresponding information related to the location and address allocated for each LED lamp module, so that it must waste a lot of money on hardware costs due to a complicated allocation operation and extra memory spaces

Thus, how to improve above-mentioned disadvantages of the known technique to make LED lamp module having a dynamically address-generating function seems to be a major concern for the present invention.

### SUMMARY OF THE INVENTION

The purpose of this invention lies in providing a novel and advanced circuit module device with address generation functions, in which, each circuit module is able to generate one relative address after receiving one addressing command, and in this way, therefore, a plurality of circuit modules, which are being electrically connected in series with each other, are able to sequentially generate addresses by way of number reporting capability, and also to send out one corresponding addressing command to the next circuit module with new generated address, hence, it will in turn successfully generate address for each circuit module so as to configure a plurality of circuit modules in this way accordingly.

In order to fulfill the above specific purposes, the present invention, therefore, presents a kind of circuit module device with address generation functions, which comprises:

A plurality of circuit modules, wherein, each circuit module is a control unit, one signal input end and one signal output end; and thereat, the said control unit has an address generation function; and the signal input ends are being electrically connected in series with signal output ends at a plurality of said circuit modules; and a plurality of said circuit modules at least consist of one primary circuit module and one secondary circuit module, in which, the signal output end of said primary circuit module is being electrically connected to the signal input end of said secondary circuit module;

Wherein, when signal input end of the said primary circuit module is receiving one primary addressing command, the control unit of said primary circuit module will respond to the said primary addressing command and generate one primary address, and then it will send out one secondary addressing command to the signal input end of said secondary circuit module; in addition, when the signal input end of said secondary circuit module is receiving the said secondary addressing command, the control unit of said secondary circuit module will respond to the said secondary addressing command and generate one secondary address; and thus, it will in turn successfully generate address for each circuit module in this way.

The circuit module device with address generation functions as defined in the preceding paragraphs, in which, each circuit module in a plurality of said circuit modules further contains one memory unit, and the said primary address is stored in the memory unit of said primary circuit module, also the said secondary address is stored in the memory unit of said secondary circuit module.

The circuit module device with address generation functions as defined in the preceding paragraphs, in which, each circuit module in a plurality of said circuit modules further contains one grounding end, so that the said primary addressing command is generated by means of pulling to high or low voltages on the signal input end of said primary circuit module.

The circuit module device with address generation functions as defined in the preceding paragraphs, wherein, a plurality of said circuit modules are a plurality of LED lamp modules.

The circuit module device with address generation functions as defined in the preceding paragraphs, wherein, each LED lamp module in a plurality of said LED lamp modules comprises one red light-emitting diode, one green light-emitting diode and one blue light-emitting diode, and thereat, the said control unit is being electrically connected with the said red light-emitting diode, the said green light-emitting diode and the said blue light-emitting diode respectively, and in this way, it will be able to control the said red light-emitting diode, the said green light-emitting diode and the said blue light-emitting diode respectively, to make it illuminating, flashing and/or changing colors.

The circuit module device with address generation functions as defined in the preceding paragraphs, wherein, each LED lamp module in a plurality of said LED lamp modules further comprises one input end of sync signal for receiving one sync signal; moreover, the said control unit is able to control said red light-emitting diode, said green light-emitting diode and said blue light-emitting diode to make it illuminating, flashing and/or changing colors while responding to the address of said LED lamp module as well as the said sync signal.

The circuit module device with address generation functions as defined in the preceding paragraphs, wherein, a plurality of said circuit modules further comprise several additional units of circuit modules, and thereat, after the generation of said secondary address, the said secondary circuit module will send out one third addressing command to one third circuit module locating in the said several additional units of circuit modules, and thereby, the said third circuit module will generate its relative address and send out addressing command in the same way and under this circumstance, thus, a plurality of the said circuit modules will in turn successfully generate address for each circuit module in this way accordingly.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing a known LED lamp module;

FIG. 2 is a schematic view showing a preferred embodiment of circuit module device with address generation functions in accordance with the present invention; and

FIG. 3 is a schematic view of LED lamp module that is an application of a preferred embodiment of circuit module device with address generation functions in accordance with the present invention.

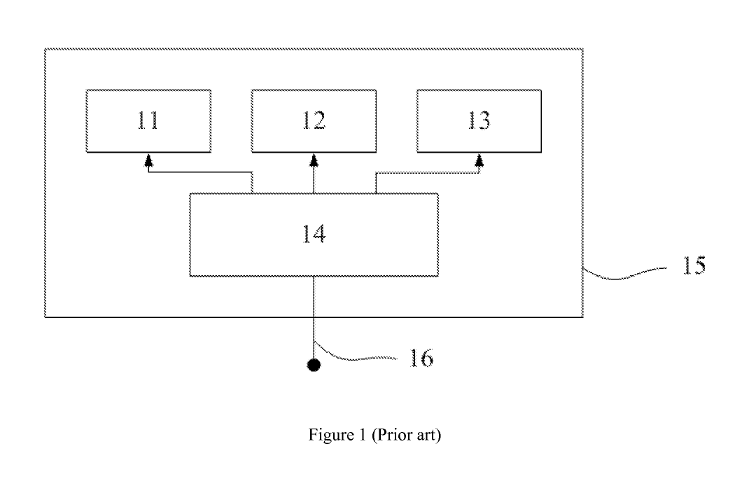

### DETAILED DESCRIPTION OF THE PREFERRED EMBODIMENT

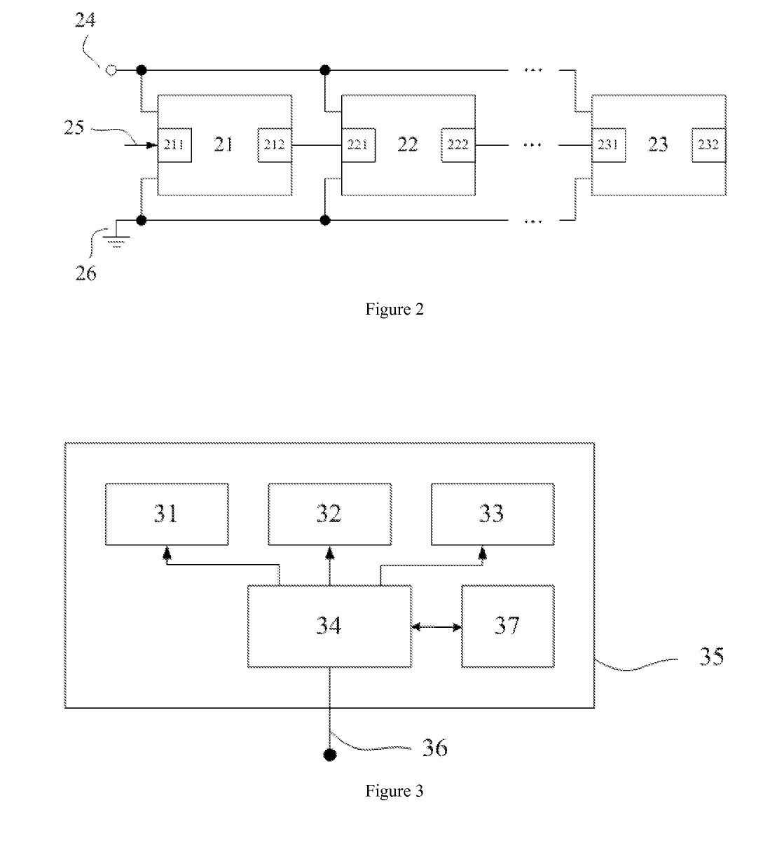

FIG. 2 is a schematic view showing a preferred embodiment of circuit module device with address generation functions in accordance with the present invention, in which, it consists of circuit module 21, 22, and 23, the signal input end 211, 221, and 231, the signal output end 212, 222, and 232, the power supply 24, the addressing command 25 and grounding 26 etc. A plurality of circuit modules 21, 22, and 23 are electrically connected to the power supply 24 and grounding 26, and moreover, these circuit modules are being electrically connected in series with each other, for instance: the signal output end 212 of circuit module 21 is electrically connected with the signal input end 221 of circuit module 22; and the signal output end 222 of circuit module 22 will be electrically connected to the signal input end at the next circuit module. Each circuit module 21, 22, or 23, comprises one control unit, which has an address generation function. While configuring the address for circuit module 21, 22, or 23, a user can input a specific addressing command 25 into the signal input end of primary circuit module appointed by such user, for instance: to input the addressing command 25 into the signal input end 211 of circuit module 21. After receiving one addressing command 25, the control unit of said circuit module 21 will respond relatively according to the instructions of said addressing command 25 to generate one primary address, and then it will send out one secondary addressing command from the signal output end 212 to the signal input end 221 of the circuit module 22. Similarly, after receiving one secondary addressing command, the control unit of circuit module 22 will respond relatively according to the instructions of said secondary addressing command to generate one secondary address, and then it will send out one third addressing command from the signal output end 222 to the signal input end of the next circuit module. Thereby, it will in turn transfer specific addressing command to the next circuit module in the same manner until the addressing operation for all circuit modules are completed successfully.

Addressing commands 25 can be generated means of pulling to high or low voltages on signal input end 211 of circuit module 21. The control unit of each circuit module 21, 22, 23 has been equipped with an adder function, so that signal value received by the signal input end will be plus one and then be transferred out off the signal output end again. For example: while pulling high or low voltages is occurred on the signal input end 211 of circuit module 21, the signal input end 211 of circuit module 21 will receive an addressing command 25 with value 0. After that, the control unit of said circuit module 21 will plus one to value o in order to generate a new address with value 1 and then it will send out one addressing command with value 1 to circuit module 22. Similarly, after receiving one addressing command with value 1, the circuit module 22 will automatically plus 1 to value 1 so as to generate one new address with value 2 and then it will send out one addressing command with value 2 to next circuit module. Consequently, in this way, each circuit module 21, 22, 23 is able to generate an individual address with an additional value plus 1 in turn respectively and hence to fulfill the purpose of addressing circuit modules. On the other hand, it is allowable to define the last circuit module, for instance: to electrically connect the signal output end 232 of circuit module 23 and the grounding 26 thereto.

FIG. 3 is a schematic view of LED lamp module that is an application of a preferred embodiment of circuit module device with address generation functions in accordance with the present invention, in which, it comprises the red light-emitting diode 31, green light-emitting diode 32, blue light-emitting diode 33, control unit 34, LED lamp module 35, sync signal input end 36 and memory unit 37. The circuit module provided by the present invention can be LED lamp module 35, wherein, the said LED lamp module 35 consists of red light-emitting diode 31, green light-emitting diode 32, blue light-emitting diode 33, control unit 34 and memory unit 37 etc. And the control unit 34 is being electrically connected to the red light-emitting diode 31, green light-emitting diode 32, blue light-emitting diode 33 as well as memory unit 37 respectively, and thereat, it can independently control each light-emitting diode to make it illuminating, flashing and/or changing colors. In addition, as described in preceding paragraphs, the control unit 34 has an address generation function, and the addresses generated by the control unit 34 are stored in the memory unit 37. Certainly, control unit 34 also can be electrically connected to the input end of sync signal 36 in order to receive sync signals.

When it is being applied to light strings, it is allowable to firstly give one addressing command to primary LED lamp module, and thereby to generate specific address for each LED lamp module one after another, and then instructing the last LED lamp module to output its address allowing the control center to find out the total numbers of LED lamp modules in the said light strings. The addresses of LED lamp modules can be generated by means of a serial number reporting function, thus, the address of LED lamp module will be directly related to its location, and under this circumstance, there is no need for the control center to record the corresponding information related to the location and address allocated for each LED lamp module, so that it will be able to control each LED lamp module more accurately.

The advantages of the present invention are as follows:

1. The circuit module device with address generation functions provided in accordance with the present invention can generate specific addresses by means of a serial number reporting function;

2. The circuit module device with address generation functions provided in accordance with the present invention can be configured in a more flexible way, that is, it is no necessary to pre-write relative address into individual circuit module at all, instead, corresponding addresses can be generated after the completion of establishment of circuit modules; and

3. When the circuit module device with address generation functions provided in accordance with the present invention is being applied to the light strings, it is no necessary for the control center to record the corresponding information related to the location and address allocated for each LED lamp module, so that it will be able to save a lot of money on hardware costs by easy allocation operation as well as without extra memory space.

From the foregoing description, it can be found that the circuit module device with address generation functions provided in accordance with the present invention is able to dynamically generating specific addresses with a novel, advanced and practical method, whereas, all modifications and changes including various applications, different designs for the circuit module, such as, using more additional sets of circuit modules or even to generate addresses through various algorithm etc., any similar structure consisting of a plurality of circuit modules and to generate specific addresses in turn for the said circuit modules may be made without departing from the scope of the present invention at all.

Although the present invention has been described with reference to the preferred embodiment that can be achieved easily by a skillful person familiar with this particular technology thereof, it is apparent to those skilled in the art that a variety of modifications and changes may be made without departing from the scope of the present invention which is intended to be defined by the appended claims.

What is claimed is:

1. A circuit module device with address generation functions, which comprises:
a plurality of circuit modules, wherein, each circuit module is a control unit, one signal input end and one signal output end; and thereat, the said control unit has an address generation function; and the signal input ends are being electrically connected in series with signal output ends at a plurality of said circuit modules; and a plurality of said circuit modules at least consist of one primary circuit module and one secondary circuit module, in which, the signal output end of said primary circuit module is being electrically connected to the signal input end of said secondary circuit module; and
wherein, when signal input end of the said primary circuit module is receiving one primary addressing command, the control unit of said primary circuit module will respond to the said primary addressing command and generate one primary address, and then it will send out one secondary addressing command to the signal input end of said secondary circuit module; in addition, when the signal input end of said secondary circuit module is receiving the said secondary addressing command, the control unit of said secondary circuit module will respond to the said secondary addressing command and generate one secondary address; and thus, it will in turn successfully generate address for each circuit module in this way.

2. A circuit module device with address generation functions as claimed in claim 1, wherein, each circuit module in a plurality of said circuit modules further contains one memory unit, and the said primary address is stored in the memory unit of said primary circuit module, also the said secondary address is stored in the memory unit of said secondary circuit module.

3. A circuit module device with address generation functions as claimed in claim 1, wherein, each circuit module in a plurality of said circuit modules further contains one grounding end; said primary addressing command is generated by means of pulling high or low voltages.

4. A circuit module device with address generation functions as claimed in claim 1, wherein, a plurality of said circuit modules are a plurality of LED lamp modules.

5. A circuit module device with address generation functions as claimed in claim 4, wherein, each LED lamp module in a plurality of said LED lamp modules comprises one red light-emitting diode, one green light-emitting diode and one blue light-emitting diode, and thereat, the said control unit is being electrically connected with the said red light-emitting diode, the said green light-emitting diode and the said blue light-emitting diode respectively, and in this way, it will be able to control the said red light-emitting diode, the said green light-emitting diode and the said blue light-emitting diode respectively, to make it illuminating, flashing and/or changing colors.

6. A circuit module device with address generation functions as claimed in claim 5, wherein, each LED lamp module in a plurality of said LED lamp modules further comprises one input end of sync signal for receiving one sync signal; moreover, the said control unit is able to control said red light-emitting diode, said green light-emitting diode and said blue light-emitting diode to make it illuminating, flashing and/or changing colors while responding to the address of said LED lamp module as well as the said sync signal.

7. A circuit module device with address generation functions as claimed in claim 1, wherein, a plurality of said circuit modules further cascades several additional units of circuit modules.
